(19) United States
(12) Patent Application Publication
(10) Pub. No.: US 2004/0223321 A1
(43) Pub. Date: Nov. 11, 2004

(54) Hands-free light focusing apparatus and method of delivering light near the fingertips of a user

(76) Inventor: Matthew Wagner Crowley, Denver, CO (US)

Correspondence Address: JOHN R LEY, LCC, 5299 DTC BLVD, SUITE 610, GREENWOOD VILLAGE, CO, 80111, US

(21) Appl. No.: 10/434,532

(22) Filed: May 9, 2003

(51) Int. Cl. F21V 21/08

(52) U.S. Cl. 362/103; 362/108; 362/285

(57) ABSTRACT

Light is delivered and focused at the fingertips of a user. A light source is positioned relative to the user by contacting an arm or a portion of a finger of the user with bendable arm or finger clip, respectively. The light source is supported substantially only from the point of contact with the user to project a beam of light at the fingertips of the user. In this manner the natural movement of the fingers is not confined or limited.

This invention relates to positioning a source of light to facilitate its more efficient use. More particularly, the present invention relates to a new and improved method of focusing and delivering light at an area of its best and most efficient use near a person's fingertips to permit the free use of both hands while assuring adequate light to perform detailed tasks.

### BACKGROUND OF THE INVENTION

Using a light to aid in performing a task requires that the light be directed onto the specific task. This usually means that the user must position the light so that a lens can direct the beam where it is needed. Aiming a flashlight in the needed direction often requires holding the light with one hand while attempting to perform a task with the other. This situation becomes inconvenient or impossible when a task requires two hands to perform. In those situations a user will enlist the help of another person to hold the light. In those situations where help cannot be obtained, the user will attempt to balance or prop the light against something to focus the light beam on the work. This situation is rarely satisfactory because of an inability to position the flashlight in optimal location where the illumination is the most needed, or because the support will not adequately hold or position the flashlight resulting in its tendency to move or get bumped out of position. The situation is further aggravated when working in confined spaces, because it is often impossible to position the flashlight in the space where it can effectively illuminate the task while still permitting the user's hands adequate space for accomplishing the task.

The user's hands frequently shade the light from the flashlight. This is especially true when performing detailed tasks requiring fingertip manipulation. To compensate for the lack of light at an object, a person may resort to working on the task in essentially a blind manner. The person lets light shine on the object by moving their hands away so that they can see what needs to be done, and then moving their hands back to shade the object while trying to accomplish the task by feel and memory. Alternating between working on and viewing an object can be awkward and frustrating and is frequently not a very effective or efficient way to accomplish a task.

Some tasks may be accomplished without illuminating an area surrounding the users fingertips. In those circumstances, too much light is unnecessary or may even be dangerous. For example, pilots flying aircraft at night prefer to have their eyes fully adjusted for night vision. Once the eyes have adapted to night vision, visual acuity increases dramatically. If a pilot illuminates a map or chart used in navigation with an excessive amount of light, the night vision adaptation of the eyes is destroyed. Illuminating a small amount of the chart with a relatively small amount of light will not substantially diminish night vision acuity. Another example is reading at night to avoid disturbing other people in the same environment. In this circumstance, only the words on the page need be illuminated. There are many other examples of circumstances where an excess amount of light beyond that necessary to accomplish a relatively confined task is undesirable.

These and other considerations have led to the improvements of the present invention.

### SUMMARY OF THE INVENTION

The present invention pertains to focusing and delivering light near a person's fingertips where it is most effectively needed to accomplish a task and while permitting the free use of both hands in accomplishing the task. The present invention obtains these improvements without the necessity to enlist another person to hold the light source, or to prop of the light source against some form of structural support. The improvements of the present invention also facilitate the more efficient and effective accomplishment of the task because the light is focused specifically on the task, and the position of the users hands and fingers does not interfere with illumination of the task. Moreover, excessive illumination is avoided in those circumstances where excess light can be detrimental.

These and other improvements are obtained by a hands-free light delivering and focusing apparatus which delivers and focuses a beam of light from a light source at the fingertips of a user. The apparatus comprises a positioning structure which positions the light source relative to the user. The positioning structure contacts one of either an arm or a portion of a finger of the user and supports the light source substantially only from the point of contact with the user to avoid limiting and confining the natural movement of the fingers. When positioned by the positioning structure, the light source delivers and focuses the beam of light in an area adjacent to the fingertips of the user. The apparatus also includes an energy source supported by the user and a photon generator which is energized by the energy source to deliver the photons generated as the beam of light from the light source.

Another aspect of the present invention which obtains similar and related improvements is a method of delivering and focusing light at fingertips of a user. The method involves projecting a beam of light from a light source, positioning the light source relative to the user by contacting one of either an arm or a portion of a finger of the user with the light source, supporting the light source substantially only from the point of contact with the user and without limiting and confining the natural movement of the fingers, generating photons, and delivering the photons the light source as the beam of light.

Further preferable aspects of the hands-free light delivering and focusing apparatus and method of delivering and focusing light at the fingertips of the user involve a finger clip that fits on the finger of the user and which supports the light source relative to the finger to project the beam of light at the tip of the finger upon which the finger clip fits. The photon generator can be positioned within the finger clip while the energy source is either in the finger clip or supported by the arm of the user, or the photon generator and the energy source can be supported by the arm of the user. An elongated bendable arm may be connected to an arm of the user and bent to curve above the hand of the user to a position adjacent a fingertip of the user. The elongated bendable arm can include a fiber optic cable. The light source can be a lens, a fiber optic cable, a light emitting diode or a miniature lamp, while the photon generator can be a light emitting diode or a miniature lamp. The light source and the photon generator can be a single device such as a light emitting diode. The energy source can be a battery or a fuel cell. A plurality of light sources may be positioned at the fingertips. The photon generator and the light source may be connected through a fiber optic cable, and the light source can be positioned at a first side of the structure and the fiber optic cable can be attached to a second different side of the structure.

A more complete appreciation of the scope of the present invention and the manner in which it achieves the above-noted and other improvements can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 is a perspective view of one embodiment of a hands-free light delivering and focusing apparatus which incorporates the present invention, shown attached to the index finger and arm of a person.

FIG. 2 is an enlarged perspective view of a power pack of the apparatus shown in FIG. 1.

FIG. 3 is an enlarged perspective view of a finger clip and electrical cable of the apparatus shown in FIG. 1.

FIG. 4 is a perspective view of the apparatus shown in FIG. 1 with the finger clip and electrical cable shown in FIG. 3 worn in an alternative position.

FIG. 5 is an enlarged perspective view of another version of the finger clip shown in FIG. 3.

FIG. 6 is an enlarged perspective view of another version the finger clip shown in FIGS. 3 and 5.

FIG. 7 is a perspective view of another embodiment of the hands-free light delivering and focusing apparatus which incorporates the present invention.

FIG. 8 is an enlarged perspective view of a power pack of the apparatus shown in FIG. 7.

FIG. 9 is an enlarged perspective view of a finger clip and a fiber optic cable of the apparatus shown in FIG. 7.

FIG. 10 is an enlarged cross section view of the finger clip shown in FIG. 9 taken substantially in the plane of line 10-10 of FIG. 9.

FIG. 11 is a perspective view of another embodiment of the hands-free light delivering and focusing apparatus which incorporates the present invention.

FIG. 12 is an enlarged perspective view of the apparatus shown in FIG. 11.

FIG. 13 is a perspective view of another embodiment of the hands-free light delivering and focusing apparatus which incorporates the present invention.

### DETAILED DESCRIPTION

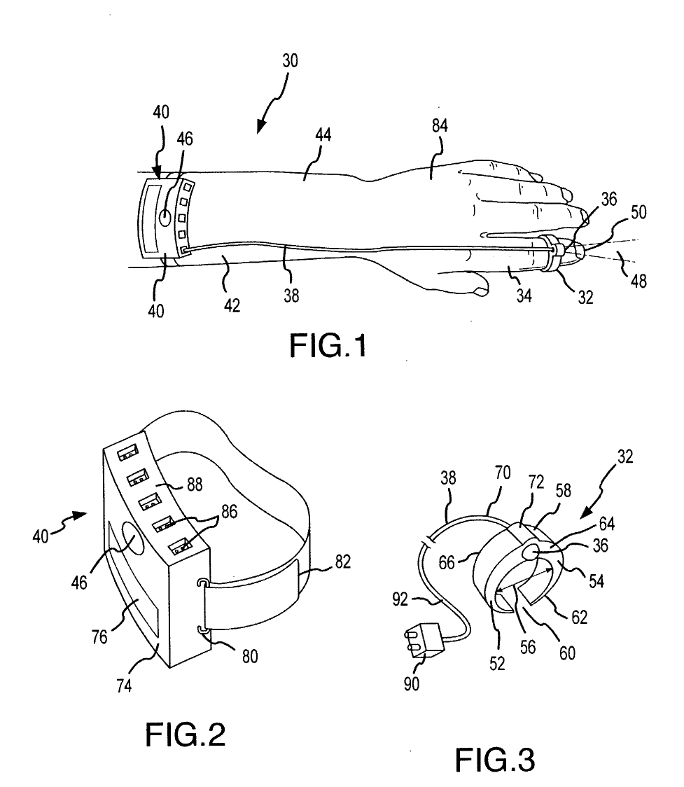

One embodiment 30 of a hands-free light delivering and focusing apparatus which incorporates the present invention is shown in FIG. 1. The apparatus 30 includes a finger clip 32 which is worn or supported on a finger 34 of a person. The finger clip 32 includes a light source 36, such as a miniature lamp or light emitting diode (LED), that is powered through an electrical cable 38 that carries electrical energy from a power pack 40 to the light source 36. The power pack 40 includes an electrical energy source (not shown), such as a battery or miniature fuel cell, which provides electrical energy to the light source 36 through electrical cable 38. The power pack 40 is attached to the users body, preferably by wearing or supporting it on a forearm 42 or wrist 44 of the user. Energy for the light source 36 is selectively conducted from the power pack 40 through the electrical cable 38 by activating a switch 46 located on the power pack 40. Powering the light source 36 causes a beam 48 of light to shine from the finger clip 32 in a focused or directed manner toward the fingertips 50 of the person using the apparatus 30, where the light beam 48 is the most effective and needed for illuminating tasks or items at the tips of the user's fingers 34.

The finger clip as shown in FIGS. 3, 6, 9, 11 and 12 are preferably formed from a resilient plastic or similar material with two opposing semicircular arms 52 and 54 that define inward facing concave curved shapes which are separated by a separating dimension 56. The arms 52 and 54 extend from a top 58 of the clip to a space 60 between the bottom ends of the arms at a bottom 62 of the finger clip 32. The finger clip 32 has a front face 64 on the arms 52 and 54 from the top 58 to the bottom 62 and a back face 66 on the opposite side of the arms 52 and 54 from the front face 64. The resilient plastic allows the bottom ends of the arms 52 and 54 to be forced away from each other and deform to enlarge the space 60 between them thereby enlarging the separating dimension 56. The plastic arms 52 and 54 have a memory to resist the deformation force so when the force is removed the arms 52 and 54 regain their original shape. To place the finger clip 32 on a user's finger 34, the arms 52 and 54 are resiliently forced apart to make the separating dimension 56 large enough to accept and fit on the user's finger 34. The arms 52 and 54 attempt to regain their original shape by resiliently pushing inward against the finger 34 to hold the finger clip 32 on the wearer's finger 34.

In the top 58 of the finger clip 32 shown in FIG. 3, there is located a light source 36 which can be any device that uses electrical power to produce photons, such as a miniature lamp or LED. The light source 36 preferably includes a lens 68 that distributes the light from the source 36 in a general direction away from the front face 64 of the finger clip 32. The electrical cable 38 enters the finger clip 32 at the back face 66, and the light source 36 is electrically connected to the distal end 70 of the electrical cable 38 in a crown 72 on the top 58 of the finger clip 32 which surrounds the connection. The crown 72 encloses all of the light source 36 except for the lens 68 which extends from the crown 72 so that light can pass from the light source 36 unimpeded. Additionally, the material forming the finger clip 32 holds the light source 36 and the electrical cable 38 securely to the finger clip 32 while keeping contaminants from the connection between the light source 36 and the electrical cable 38. The crown 72 is formed by encasing the light source 36 if the light source 36 is larger than the front face 64 of the finger clip 32. If the front face 64 of the finger clip 32 is larger than the light source 36 then the crown 72 is not needed and the light source 36 and connection to the electrical cable 38 are embedded in the material forming the top 58 of the finger clip 32.

The power pack 40, shown in FIG. 2, includes a plastic housing 74 that is generally rectangular shaped with a slight curvature along one axis. The battery or fuel cell (not shown) is installed within the power pack 40 in a battery compartment covered by a cover 76 as shown in FIG. 2. The cover 76 is removable to allow a spent battery or fuel cell to be removed and a new battery or fuel cell to be installed.

The power pack 40 has brackets on opposite ends that attach to a band 82 with hook and loop type fasteners. The hook and loop band 82 attaches to a first bracket (not shown) on one side of the power pack 40 and extends to a second bracket 80 on the opposite side of the power pack 40 where it can be looped through the second bracket 80 and attached to itself as shown in, FIG. 2. In this manner, the power pack 40 can be securely held to the forearm 42 or wrist 44 of a person by adjusting the hook and loop band 82 to the size needed.

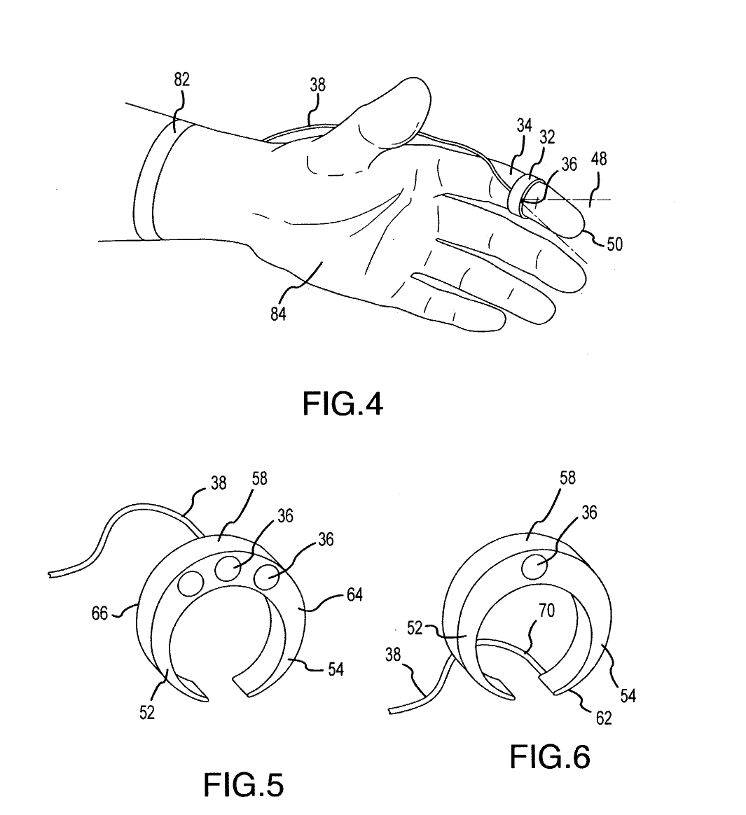

The finger clip 32 in FIG. 1 is shown positioned on the finger 34 so that the light source 36 is on the top 58 of the finger 34 or toward the back side of a hand 84. In this position light 48 from the light source 36 shines over the top of the finger 34 to illuminate an area essentially at the fingertip 50. In this way light 48 from the light source 36 can be directed to the area where it is needed in a convenient manner. The position shown in FIG. 1 also allows the use of the inside of the hand 84 to grasp larger objects without having the light source 36 interfere. Because of the separating space 56 between the arms 52 and 54, the finger clip 32 can be rotated around the finger 34 to position it at a selected circumferential orientation with respect to the finger 34. In this way the finger clip 32 can be positioned as is shown in FIG. 4, for example, to shine light beam 48 on the inside or palm side of the finger 34 where it could be particularly useful to aid in picking up small items with the index finger and thumb.

In the embodiment shown in FIGS. 1-3 the power pack 40 has a series of electrical receptacles 86 in a front face 88 that are configured to receive a plug 90 on the proximal end 92 of the electrical cable 38 attached to the finger clip 32. The receptacles 86 are electrically connectable to the internal power source through the conventional push button type power switch 46 that can be activated to alternate between an on state that connects the electrical power to the receptacles 86, and an off state that disconnects the power source from the receptacles 86.

The power pack 40 shown in FIGS. 1 and 2 includes enough receptacles 86 to attach multiple finger clips 32, but there could be more or less than the five receptacles 86 shown in FIGS. 1 and 2. If the user needs more light 48 than that available from one finger clip 32, multiple single finger clips 32 can be worn on the fingers 34 of the user and each one of the multiple finger clips 32 is connected to the power pack 40 at a receptacle 86 with a separate electrical cable 38. Multiple finger clips 32 can be easily attached or removed from the power pack 40 by using the plug 90 and receptacle 86. Powering only the number of light sources 36 needed uses less energy so battery life or fuel cell capacity is extended.

As an alternative to wearing multiple finger clips 32 if more light 48 is needed at the fingertip 50, the finger clip 32 can be made with multiple light sources 36 as shown in FIG. 5. Powering multiple light sources 36 can be accomplished by a single electrical cable 38 because the power requirements for each light source 36 is typically small.

To facilitate use of the finger clip 32 in a comfortable and convenient position which is not adversely influenced by the position of the electrical cable 38, the electrical cable 38 can be attached to the finger clip 32 at the bottom end 62 of one of the arms 52 or 54 as shown in FIG. 6. This allows the electrical cable 38 to pass out of the way over the back of the hand 84 while the light 48 shines from the inside of the hand 84. Longer or shorter electrical cables 38 can be provided depending on the needs of the user.

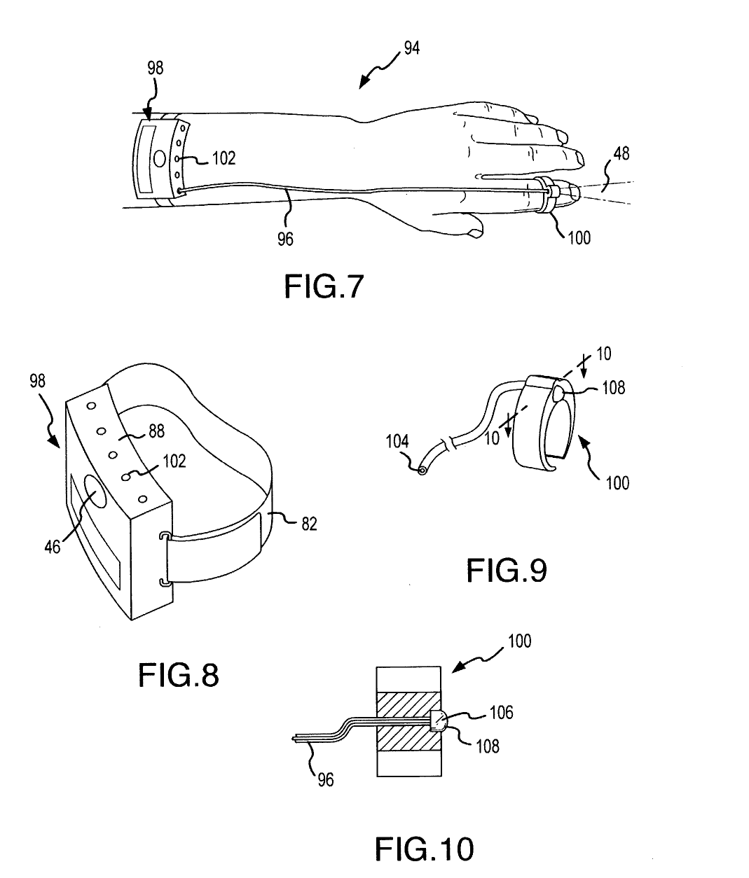

Another embodiment 94 of the hands-free light focusing and delivering apparatus which incorporates the present intention is shown in FIGS. 7-10. The hands-free light focusing and delivering apparatus 94 incorporates a fiber optic cable 96 to conduct light from a power pack 98 to a finger clip 100. The power pack 98 includes an internal photon generator, such as a miniature lamp or LED (not shown), that can be any device that uses electrical power to produce photons. The photon generator is optically connected to a series of optical receptacles 102 in the front face of the power pack 98. A proximal connector 104 on the fiber optic cable 96 is inserted into the optical receptacle 102, to align the fiber optic cable 96 to receive light from the photon generator. The fiber optic cable 96 conveys this received light to the finger clip 100 where the distal end of the fiber optic cable 96 or a lens 106 acts as the light source 108.

The finger clip 100 shown in FIGS. 9 and 10 has a lens 106 attached to the top 58. The light is delivered to the lens 106 from the fiber optic cable 96 and the lens 106 causes the light to be delivered and focused in the light beam 48 on a point established by the optical characteristics of the lens 106, as shown in FIG. 7. Although a lens 106 is shown as used in the finger clip 100, the lens 106 is not necessary if the distal end of the fiber optic cable 96 itself is shaped as a lens to focus the light in a beam 48.

The optical receptacles 102 receive the proximal connector 104 of the fiber optic cable 96 and hold the cable 96 securely in alignment with the photon generator. In this alignment the photon generator transmits light through the optical receptacles 102 into the fiber optic cable 96 where the light is then transmitted to the finger clip 100. Power from the battery to the photon generator in the power pack 98 is controlled by a push button 46 in the same way as the power pack 40 shown in FIG. 2.

Multiple light sources 108 can be incorporated in the single finger clip 100 to deliver additional light beams 48, in a manner similar to the circumstance illustrated in FIG. 5. Moreover, multiple finger clips 100 can be worn by the user. One or more fiber optic cables 96 are connected to the power pack 98 and to each of the light sources 108 in these circumstances. The finger clip 100 shown in FIG. 9 can also be positioned on the finger 34 to shine from the inside or outside of the hand 84 or other positions as necessary similar to the finger clip 32 shown in FIG. 4. Also, the fiber optic cable 96 can connect to the bottom end 62 of one of the arms 52 or 54 of the finger clip 100 in a manner similar to that shown in FIG. 6. Additionally the fiber optic cables 96 can be different lengths so that the finger clips 100 can be farther or closer to the power pack 98.

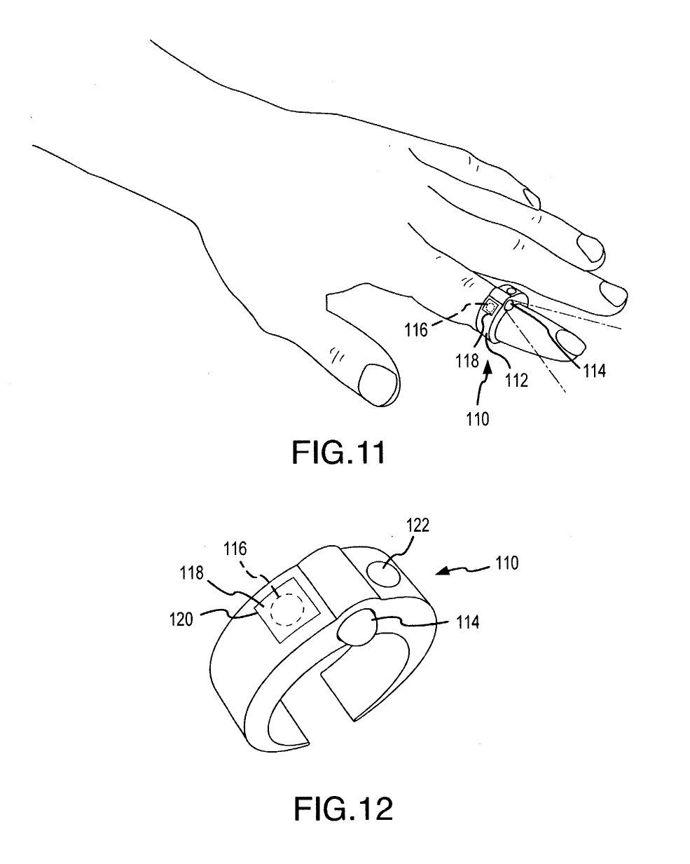

Another embodiment 110 of the hands-free light delivering and focusing apparatus delivery is shown in FIGS. 11 and 12. The hands-free light delivering and focusing apparatus 110 is essentially entirely incorporated within a finger clip 112, such that the light source 114 and power pack 116 are contained within the finger clip 112. A button cell type battery (not shown) is installed in a battery compartment 118 in one of the finger clip arms 52. A battery cover 120 holds the battery in place and keeps contaminants out of the battery compartment 118. The button cell is electrically connected to a miniature pushbutton power switch 122 which selectively connects and disconnects the light source 114 to and from the battery. The finger clip 112 is formed from a resilient plastic material that deforms to fit the finger 34 of the user and when worn as shown in FIG. 11, the light beam 48 illuminates past the end 50 of the finger 34 of the wearer. As with the previous embodiments if more light is desired, then multiple clips 112 can be worn or each clip 112 can have multiple light sources 114. Also, the clip 112 can be positioned so that the light source 114 is in different positions circumferentially around the finger 34 to shine the light beam 48 where it is most needed.

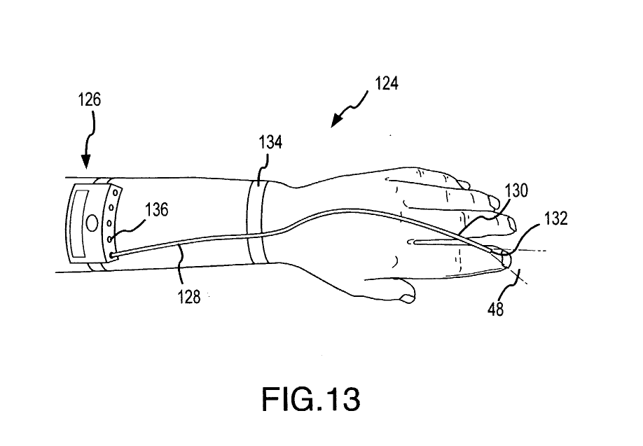

Another embodiment 124 of a hands-free light delivering and focusing apparatus which incorporates the present intention is shown in FIG. 13. The hands-free light delivering and focusing apparatus 124 utilizes a power pack 126 with an internal photon generator (not shown) and a bendable structure 128 which extends proximally from the power pack 126 to a distal end 130 located adjacent to the fingertips 50. The distal end 130 of the bendable structure 128 includes a light source 132. The light source 132 may be electrically powered, such as a miniature lamp or LED, in which case the bendable structure 128 functions as a conduit for confining an electrical cable (not shown) to deliver energy from the power pack 126 at the receptacles 136 to the light source 132. The light source 132 may also be an optical lens or the distal end of a fiber optic cable (not shown) which has the characteristics of an optical lens, in which case the bendable structure 128 functions as a conduit for confining a fiber optic cable to deliver light energy from the power pack 126 at the receptacles 136 to the light source 132.

In the hands-free light delivering and focusing apparatus 124 a finger clip is not required because the bendable structure 128 positions the light source 132 at the desired location to project the light beam 48 near the fingertips 50. Instead, it is advantageous to connect the bendable structure 128 to the wrist 44 with a wrist strap 134 to facilitate a more stable location of the bendable structure 128 relative to the user's fingertips 50. The wrist strap 134 also prevents the connection between the bendable structure 128 and the power pack 126 from absorbing all of the mechanical load and stress necessary to position the bendable structure 128 in the desired location.

When the bendable structure 128 includes an electrical cable leading to a light source in the form of a miniature lamp or LED at the distal end of the bendable structure 128, the power pack 126 is similar to the power pack 40 shown in FIGS. 1 and 2. Power is conveyed from the power pack 128 to the receptacles on the front 88 of the power pack 126. The electrical cable attaches to the receptacle 136 at its proximal end and passes through the bendable structure 128 to its distal end where it is connected to the light source 132. Power is conveyed from the receptacles 136 to the light source 132 with the electrical cable to energize the light source 132 to produce the light beam 48.

When the bendable structure 128 includes a fiber optic cable, the power pack 126 is similar to the power pack 98 shown in FIGS. 7 and 8 in that it has a built in photon generator that emits light and is optically connected to the optical receptacles 136 on the front face 88 of the power pack 126. When a fiber optic cable is inserted into the optical receptacles 136, light from the photon generator is directed into the fiber optic cable.

The embodiments of the hands-free light delivering and focusing apparatus, and its method of use for delivering the light beam 48 to the fingertip 50 area of the user allows the user the freedom to work with both hands because the light 48 is delivered to the area where it is needed the most. By wearing the finger clip 32, 100 or 112, the user is able to adjust the light 48 onto a task by simply moving a finger 34, rather than holding a light with one hand while attempting to do work with the other hand, or having another person hold the light. The full tactile feel and manipulation available from the user's fingers is not impeded, as would be the case if gloves or other more confining devices needed to be worn in order to project the light in the desired location. It is not necessary to resort to balancing or propping a light against a support in order to have light directed were needed. Instead, because the inherent delivery of the light beam 48 at the fingertip location 50, the light is always available where it is most needed. The user's hands 84 and fingers 34 do not shade the work area so the full senses of both tactile feel and sight are available to perform the task. These and other improvements and advantages will be more apparent after comprehending the full ramifications of the present invention.

Presently preferred embodiments of the invention and many of its improvements have been described with a degree of particularity. This description is of preferred examples of implementing the invention, and is not necessarily intended to limit the scope of the invention. The scope of the invention is defined by the following claims.

What is claimed:

1. Apparatus for delivering and focusing light at fingertips of a user, comprising:
a light source which projects a beam of light;
a positioning structure which positions the light source relative to the user to deliver and focus the beam of light in an area adjacent to the fingertips of the user, the positioning structure contacting one of either an arm or a portion of a finger of the user and supporting the light source substantially only from the point of contact with the user to avoid limiting and confining the natural movement of the fingers;
an energy source supported by the user; and
a photon generator associated with the light source and connected to the energy source, the photon generator generating photons which are delivered from the light source as the beam of light.

2. Apparatus as defined in claim 1, wherein:
the structure comprises a finger clip that fits on a finger of the user and which supports the light source relative to the finger to project the beam of light at the tip of the finger upon which the finger clip fits.

3. Apparatus as defined in claim 2, wherein:
the energy source and the photon generator are positioned within the finger clip.

4. Apparatus as defined in claim 2, wherein:
the photon generator is positioned within the finger clip and the energy source is supported by the arm of the user.

5. Apparatus as defined in claim 2, wherein:
the energy source and the photon generator are supported by the arm of the user.

6. Apparatus as defined in claim 1, wherein:
the structure comprises an elongated bendable arm that is connected to an arm of the user and which curves above a hand of the user to a position adjacent a fingertip of the user.

7. Apparatus as defined in claim 6, wherein:
the elongated bendable arm comprises a fiber optic cable.

8. Apparatus as defined in claim 1, wherein:
the light source is selected from the group consisting of a lens, a fiber optic cable, a light emitting diode, and a miniature lamp.

9. Apparatus as defined in claim 1 wherein:
the photon generator is selected from the group consisting of a light emitting diode and a miniature lamp.

10. Apparatus as defined in claim 1, wherein:
the photon generator and the light source comprise a light emitting diode.

11. Apparatus as defined in claim 1, wherein:
the energy source is selected from the group consisting of a battery and a fuel cell.

12. Apparatus as defined in claim 1, wherein:
the positioning structure positions a plurality of light sources.

13. Apparatus as defined in claim 1, wherein:
the photon generator and light source are connected through a fiber optic cable; and
the light source is positioned at a first side of the structure and the fiber optic cable is attached to a second different side of the structure.

14. A method of delivering and focusing light at fingertips of a user, comprising:
projecting a beam of light from a light source;
positioning the light source relative to the user by contacting one of either an arm or a portion of a finger of the user with the light source;
supporting the light source substantially only from the point of contact with the user and without limiting and confining the natural movement of the fingers;
generating photons; and
delivering the photons from the light source as the beam of light.

15. A method as defined in claim 14, further comprising:
attaching a finger clip to the finger of the user; and
supporting the light source with the finger clip.

16. A method as defined in claim 15, further comprising:
generating the photons within the finger clip.

17. A method as defined in claim 14, further comprising:
supporting the light source with an elongated bendable arm;
connecting the bendable arm to an arm of the user; and
curving the bendable arm above a hand of the user to a position the light source adjacent a fingertip of the user.

18. A method as defined in claim 14, further comprising:
supporting a plurality of light sources.

19. A method as defined in claim 14, further comprising:
positioning a plurality of light sources.

20. A method as defined in claim 14, further comprising:
generating photons at the light source.
